(19) United States
(12) Patent Application Publication
(10) Pub. No.: US 2023/0385764 A1
(43) Pub. Date: Nov. 30, 2023

(54) INTELLIGENT BALANCING OF ITEMS MANAGED IN AN INFORMATION PROCESSING SYSTEM

(71) Applicant: Dell Products L.P., Round Rock, TX (US)

(72) Inventors: Rohit Gosain, Bangalore (IN); Ajay Maikhuri, Bangalore (IN); Shibi Panikkar, Bangalore (IN)

(21) Appl. No.: 17/828,347

(22) Filed: May 31, 2022

(51) Int. Cl. G06Q 10/08; G06Q 10/06

(52) U.S. Cl. CPC G06Q 10/0875; G06Q 10/06315; G06Q 10/06314

(57) ABSTRACT

Automated item management techniques comprising balancing of items across a plurality of sites are disclosed. For example, for a given item type stored as inventory at a plurality of sites, a method predicts a stock factor for each of the plurality of sites based on historical stock factor data. The method also predicts an aging items count for each of the plurality of sites based on historical aging item data. The method computes a plan, based on the predicted stock factor and the predicted aging items count for each of the plurality of sites, to move an amount of the given item type between two or more of the plurality of sites to satisfy a demand forecast at each site.

### FIELD

The field relates generally to information processing systems, and more particularly to automated item management in such information processing systems.

### BACKGROUND

There are many technical scenarios whereby entities attempt to manage items in their control with a goal of minimizing one or more negative consequences from occurring. In one example, such a management scenario may comprise inventory items that an original equipment manufacturer (OEM) manages across multiple sites (e.g., facilities or locations) at which parts or material used in the manufacturing processes of equipment are stored. Further, by way of example, it may be necessary for the OEM to have parts moved from a first site to a second site based on a demand shortage at the second site. However, conventional inventory item management techniques are manual and reactive in nature leading to significant negative consequences for the OEM.

### SUMMARY

Illustrative embodiments provide automated item management techniques comprising balancing of items across a plurality of sites in an information processing system.

For example, in an illustrative embodiment, for a given item type stored as inventory at a plurality of sites, the method predicts a stock factor for each of the plurality of sites based on historical stock factor data. The method also predicts an aging items count for each of the plurality of sites based on historical aging item data. The method computes a plan, based on the predicted stock factor and the predicted aging items count for each of the plurality of sites, to move an amount of the given item type between two or more of the plurality of sites to satisfy a demand forecast at each site.

Advantageously, one or more illustrative embodiments further provide for causing the plan to be initiated by the two or more of the plurality of sites, and revising a supply forecast based on the plan.

These and other illustrative embodiments include, without limitation, apparatus, systems, methods and computer program products comprising processor-readable storage media.

### BRIEF DESCRIPTION OF THE DRAWINGS

FIG. 1 illustrates an inventory management environment with which one or more illustrative embodiments can be implemented.

FIGS. 2A through 2F illustrate an inventory use case with which one or more illustrative embodiments can be implemented.

FIG. 3 illustrates a supply planning process with which one or more illustrative embodiments can be implemented.

FIG. 4 illustrates an information processing system environment comprising an intelligent inventory item balancing engine according to an illustrative embodiment.

FIG. 5 illustrates transportation cost data in an inventory use case according to an illustrative embodiment.

FIG. 6 illustrates site clusters in an inventory use case according to an illustrative embodiment.

FIG. 7 illustrates stock factor data in an inventory use case according to an illustrative embodiment.

FIG. 8 illustrates a stock factor graphical plot according to an illustrative embodiment.

FIG. 9 illustrates an information processing system environment comprising details of an intelligent inventory item balancing engine according to an illustrative embodiment.

FIGS. 10A through 10D illustrate an inventory use case according to an illustrative embodiment.

FIG. 11 illustrates an intelligent inventory item balancing methodology according to an illustrative embodiment.

FIG. 12 illustrates an example of a processing platform that may be utilized to implement at least a portion of an information processing system for intelligent inventory item balancing according to an illustrative embodiment.

### DETAILED DESCRIPTION

Supply chain management in the manufacturing industry typically refers to the process of monitoring and taking actions required for a manufacturer, such as an OEM, to obtain raw materials (i.e., parts), convert those parts into a finished product (equipment) at one or more manufacturing facilities (sites), and then deliver or otherwise deploy the equipment at a customer location. A goal of supply chain management with respect to the parts is to adequately manage supply and demand, e.g., the supply of the parts (the parts procured or otherwise acquired from vendors, etc.) versus the demand of the parts (e.g., the parts needed to satisfy the manufacturing of equipment ordered by a customer). Management of the parts has been a challenge in the traditional and now modern supply chain processes.

OEMs typically procure parts in bulk based on a demand trigger. It is also typical practice for an OEM to source the total quantity needed for a given part type from different suppliers. If a part is not used, different suppliers have different part return policies (aging policies, as illustratively used herein), e.g., some suppliers have a 90-day return policy and some have 120-day return policy. Accordingly, if an unused part is not returned by the OEM to the vendor by the expiration of the return date (e.g., 90 or 120 days from OEM's receipt of the part), then the OEM may not be entitled to a refund (e.g., full or partial). Also, a part may have an expiration date established by the vendor or other entity, and therefore must be used before that expiry date. Thus, in this illustrative OEM scenario, the term aging of a part may illustratively refer to the length of time, since receipt, that the part has been in the inventory of the OEM without being consumed (e.g., used in an assembled unit of equipment or otherwise in the manufacturing process).

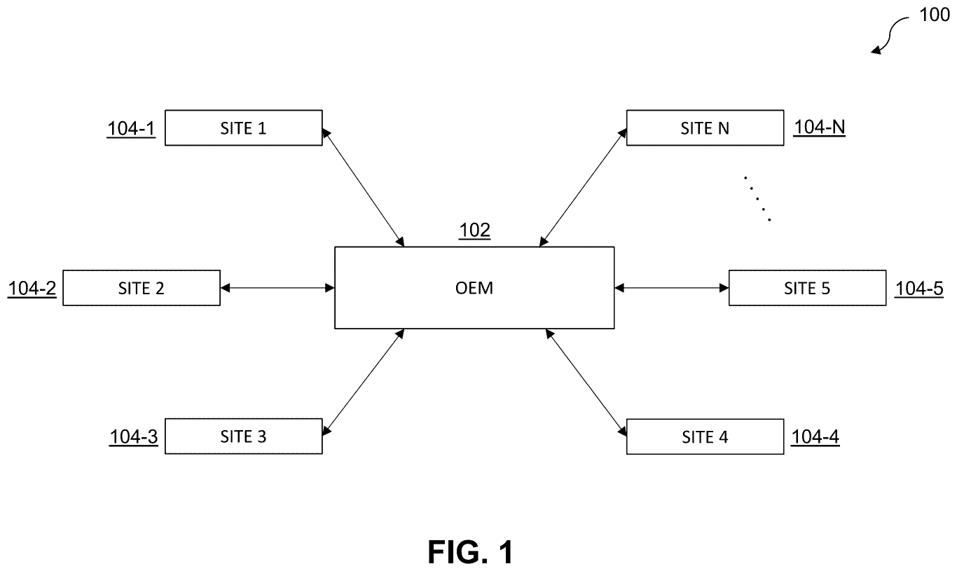

Referring initially to FIG. 1, an inventory management environment 100 is illustrated wherein an OEM 102 manages inventory items, such as parts used in equipment manufacturing as mentioned above, across a plurality of sites 104-1, . . . 104-N(also collectively referred to herein as sites 104, or individually as site 104). It is to be appreciated that it may be necessary, or otherwise desired, for OEM 102 to move items between two or more sites 104 in order to rebalance (or interchangeably referred to as balance) the overall inventory among the different sites 104. In conventional inventory management, rebalancing of the inventory typically occurs in a reactive and ad-hoc manner, thus increasing the cost of the material and, moreover, effecting the next cycle of supply planning (procurement).

By way of example, in the conventional manufacturing industry, three types of material movements typically occur:

(1) Assume site 104-1, as compared to other sites 104, has a higher inventory of aging parts of a particular type such that these parts must be consumed within a bounded time to avoid waste, as mentioned above. Thus, the inventory team of OEM 102:

(a) finds out one or more other sites 104 at which that part has more demand, e.g., assume that is site 104-2;

(b) calculates the logistics cost of moving parts between site 104-1 and 104-2 versus procuring the same at site 104-2; and if moving material is more effective, then ships the material to site 104-2; or

(c) else scraps the same post aging or plans for return if it falls under a return policy, as mentioned above.
(2) Assume site 104-1, as compared to other sites 104, has a surplus inventory of a part type and site 104-2 has a shortage. Thus, the inventory team of OEM 102:
(a) calculates the logistics cost of moving parts between site 104-1 and 104-2 versus procuring the same at site 104-2; and
(b) if moving material is more effective, then ships the parts to site 104-2, otherwise procures the parts at site 104-2.
(3) Assume material is on its way to site 104-1 (in transit) which has a surplus inventory but site 104-2 has more demand, then the inventory team of OEM 102 re-routes the parts to site 104-2.

In conventional inventory management approaches in the manufacturing industry, the above three scenarios occur in a reactive, ad-hoc, and manual manner when there is a demand (order) to a specific site. The inventory team of OEM 102 raises a material movement request (MMR) once the real demand is about to flow. It is thus realized herein that, due to the urgency, most MMRs result in a need to plan for an airship movement, which increases costs for OEM 102. Also, it is realized herein that this material movement is not accounted for in the next demand forecast and, hence, produces a less accurate demand forecast and thus inaccurate site procurement, which only worsens with time.

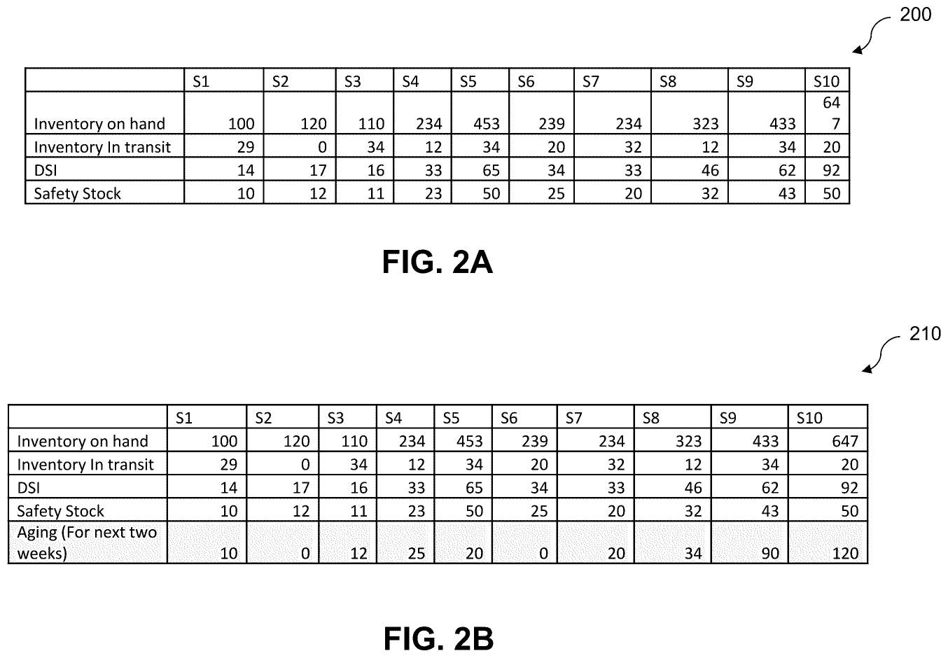

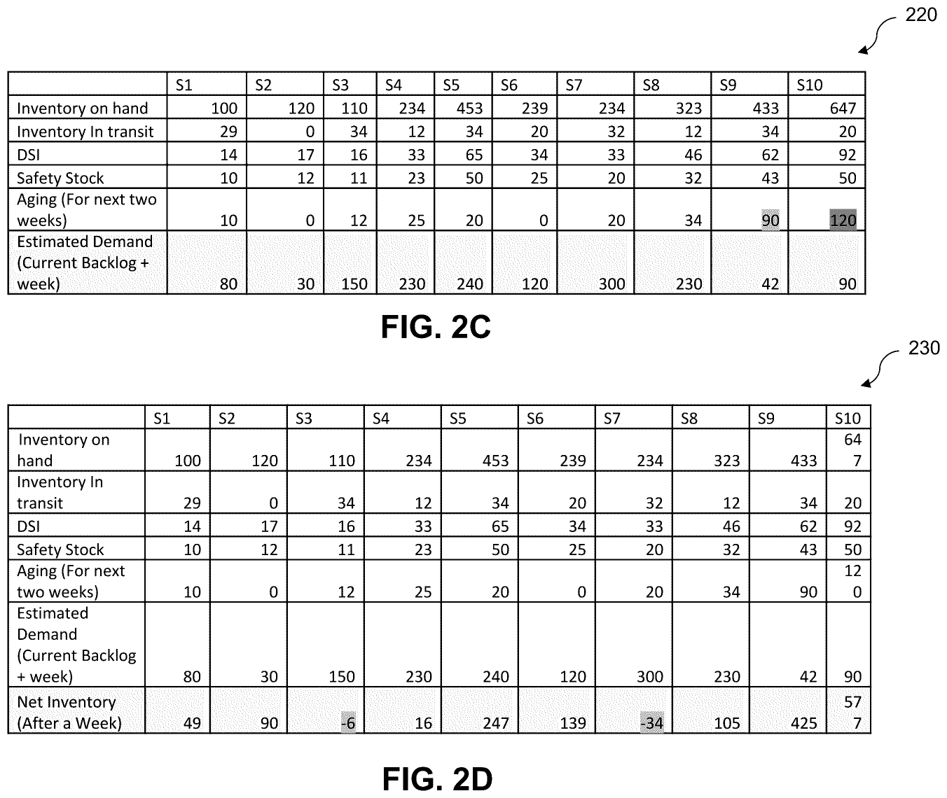

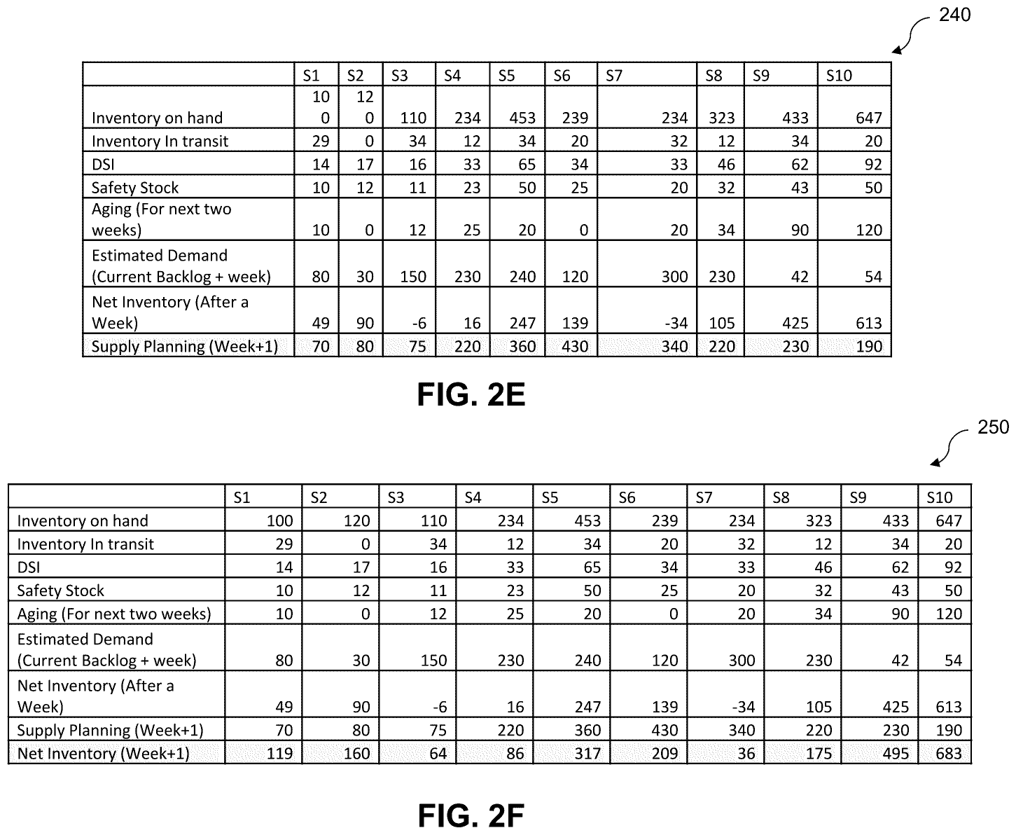

FIGS. 2A through 2F tabularly depict an inventory use case to further illustrate the above technical issues. Assume there are 10 manufacturing sites, i.e., S1-S10, and assume a specific type of part P.

Table 200 of FIG. 2A shows a current state of inventory. Inventory on hand refers to present stock, inventory in transit refers to inventory that already shipped from a supplier but has not reached the site, DSI (days sales in inventory) refers to an average daily consumption rate, and safety stock refers to the minimum stock to be maintained at the site.

Table 210 of FIG. 2B shows the aging of part P at each site, i.e., how many parts will reach their return date limit or otherwise expire in two weeks. The parts that meet such aging criteria are referred to as aging parts or, more generally, aging items.

Table 220 of FIG. 2C shows the current backlog (existing orders) and the next week demand estimate. A first technical issue evident is that the demand consume for S10 reflected as Estimated Demand (Current Backlog+Week) is 90, and the number of aging parts is 120, leaving aging parts at S10, i.e., 120−9=30. S9 also falls in the same issue category, i.e., 90−42=48 aging parts.

With reference to table 230 of FIG. 2D, the net inventory on hand after a week time period is shown wherein net inventory is equal to inventory on hand plus inventory in transit minus estimated demand (Current Backlog+Week). Clearly, as table 230 depicts, the orders at S3 and S7 are in trouble. This situation is when, in conventional inventory management approaches, the inventory team takes action and manually determines a mitigation response for S3 and S7. They look where the surplus inventory is and create an MMR to move inventory from one or more surplus sites to the one or more problem sites. Other mitigation responses can be to order from suppliers or to re-route the in transit inventory for S9 to S7. Since there is only a week time to go, most probably they will go with air shipment the cost of which will be very high, thus exposing a second technical issue. Thereafter, the next week supply planning will run as usual. However, the mitigation response manually implemented by the inventory team does not get recorded, and suppliers will supply material based on the historical demand produced and not take in to account the mitigation response. This is reflected in supply planning (Week+1) in table 240 of FIG. 2E.

Table 250 of FIG. 2F then depicts the net inventory on hand after a week. As is evident, S3 and S4 are in trouble and S2 is tending toward a relatively high inventory, S8 is going relatively low and S9 and S10 still have relatively high inventories. With the next estimated demand in a week, the manual mitigation cycle continues, exposing yet a third technical issue with existing inventory management approaches.

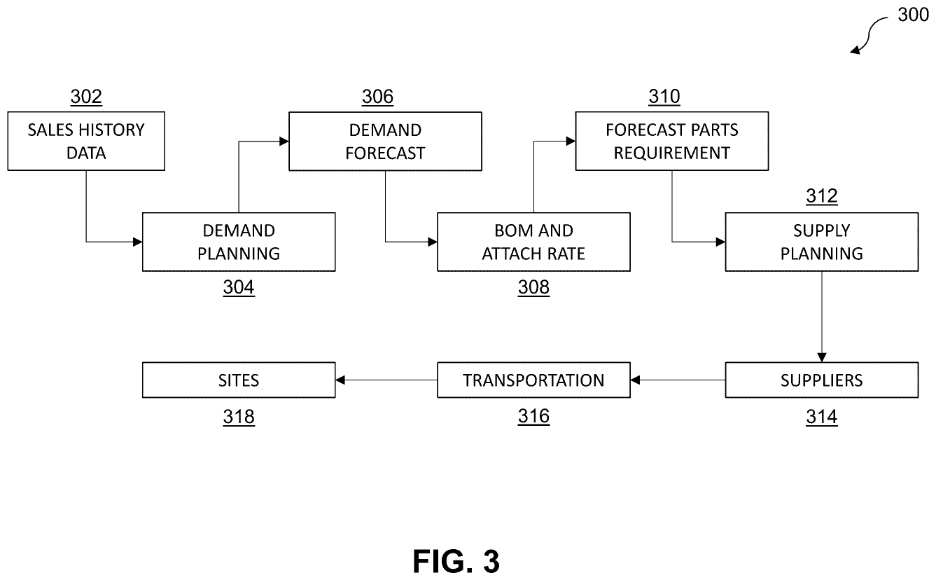

FIG. 3 summarizes an existing supply planning process 300 used by an OEM. As shown, sales history data 302 is used in a demand planning step 304 (e.g., using a Bayesian network and linear regression) to generate a demand forecast 306 at a system level. Given the demand forecast 306, a bill of materials is generated (referred to as to BOM out) therefrom along with an attach rate in a BOM and attach rate step 308. In a parts requirement forecast step 310, e.g., linear regression is performed. Supply planning step 312 causes procurement of parts from one or more suppliers 314. The procured parts are transported in transportation step 316 to one or more sites 318 of the OEM. However, as pointed out in the use case of FIGS. 2A through 2F, manual attempts to rebalance inventory at the one or more sites 318 are, at best, reactive and ad hoc in nature.

Illustrative embodiments overcome the above mentioned and other technical issues associated with conventional inventory management by providing techniques to proactively manage inventory usage and rebalance inventory among sites. Such techniques advantageously influence supply planning for rebalancing the inventory rather than procuring from suppliers to minimize the ad-hoc material movements and aging of parts.

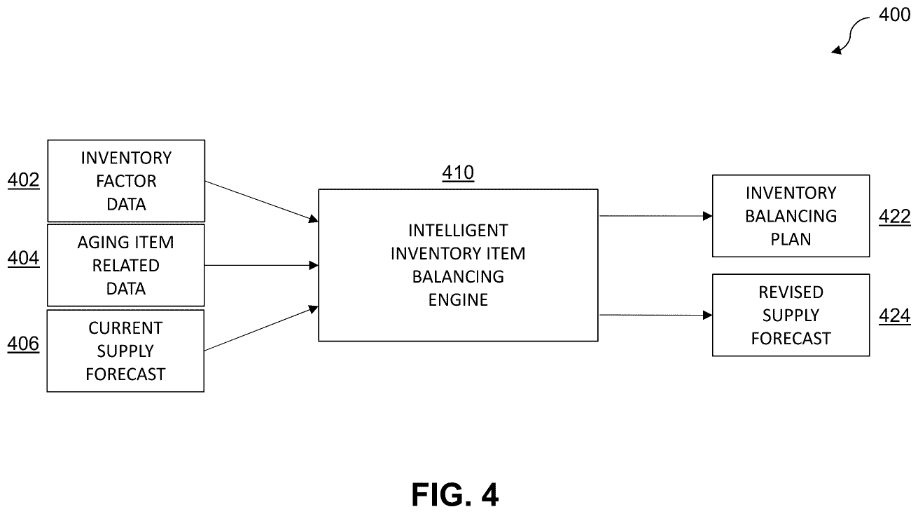

FIG. 4 illustrates an information processing system environment 400 comprising an intelligent inventory item balancing engine according to an illustrative embodiment. As illustratively used herein, the term inventory item can be a part or other material (e.g., a particular type of a disk drive, an integrated circuit chip comprising a processor and/or memory, a software package, etc.) in an equipment manufacturing operation (e.g., OEM manufacturing of a storage array, server, or other computing system). However, it is to be understood that the improved inventory management techniques described herein are not limited to an OEM manufacturing environment, and thus the term inventory item is intended to represent a wide variety of items having a wide variety of applications.

As shown in FIG. 4, inventory factor data 402, aging item related data 404, and a current supply forecast 406 are input to an intelligent inventory item balancing engine 410 which is configured to generate an inventory balancing plan 422 and a revised supply forecast 424.

As will be explained in further detail herein, intelligent inventory item balancing engine 410 assesses current inventory allocations and adjusts supply planning incorporating proactive inventory balancing. Such proactive inventory balancing, inter alia, enables more cost-effective transportation for inter-site transfer, reduces supply requests to suppliers, reduces or otherwise eliminates manual and ad-hoc material movement for mitigating parts shortage risk, and reduces or otherwise eliminates the risk of aging material.

It is realized herein that indicators that lead to inventory imbalance may include, but are not limited to, one or more of: (i) stock out situation frequency; (ii) reduction in order-fill-rate or OFR (OFR is a fraction of customer demand met from on hand inventory and in transit inventory); (iii) aging of inventory due to expiry; (iv) aging of inventory due to seasonality; and (v) stock factor for every site and item (inventory/estimated demand). A relatively high stock factor indicates inventory surplus and a relatively low stock factor indicates inventory shortage. The stock factor includes safety stock in some illustrative embodiments.

From the above indicators, it is further realized that main driving factors for inventory item balancing may include, but are not limited to, one or more of: (i) stock out metrics history (e.g., frequency, time, and duration); (ii) OFR history, i.e., (satisfied demand/actual demand)*100, over a period of time; (iii) DSI rate, i.e., (DSI— inventory/day demand), over a period of time; and (iv) holding cost of site (e.g., each site inventory storing charge may be different).

Still further, it is realized herein that constraints for inventory item balancing may include, but are not limited to, one or more of: (i) need to minimize transportation cost for inter-site transfer; (ii) need to minimizer holding cost (e.g., store less stock in high-cost areas); (iii) shelf life of item (e.g., if shelf life if item is more, keep item; if item is aging, need to consume or return); (iv) need to maintain safety stock; and (v) supplier proximity (e.g., if supplier can ship)

As such, some primary objectives of inventory item balancing may include, but are not limited to, one or more of: (i) reducing DSI; (ii) reducing transportation cost; (iii) avoiding parts shortage; (iv) avoiding aging; and (v) improving procurement.

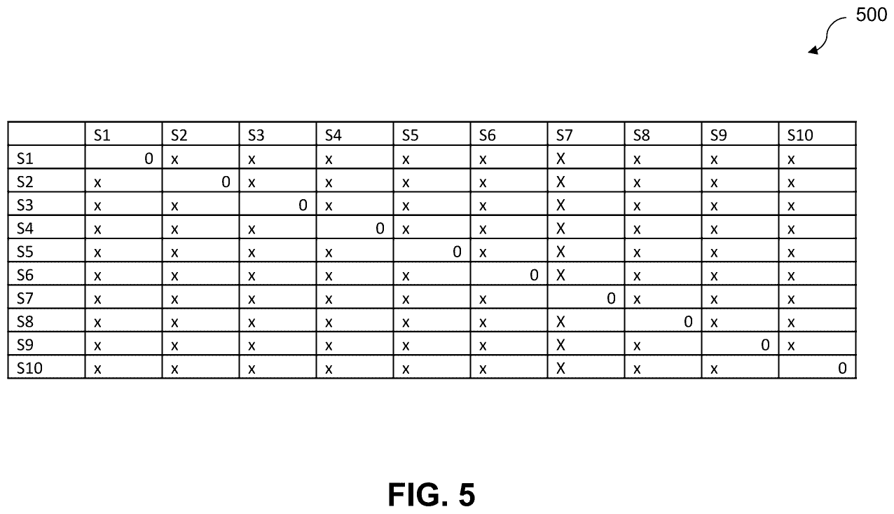

Inventory item balancing operations should also have knowledge of site-to-site transfer costs. Table 500 of FIG. 5 conceptually shows inter-site transportation costs between sites S1-S10 from the above-described use case. This includes knowing the costs for each transportation type, e.g., air, ocean and ground transportation. As mentioned, air transportation, while the fastest, is typically the most expensive, followed by ocean transportation and then road transportation. Additionally, how long each transportation type will take to get items from one site to another should be known.

In one or more illustrative embodiments, intelligent inventory item balancing engine 410 takes into account one or more of the above and other indicators, factors, constraints, objectives and considerations. In so doing, intelligent inventory item balancing engine 410 is configured to one or more of: (i) classify low-cost transportation site clusters (i.e., groupings of two or more sites based on one or more clustering criteria such as, for example, geographic proximity, ease of transportation, etc.); (ii) obtain the stock factor data for each site (e.g., 402 in FIG. 4) and aging related data for each site (e.g., 404 in FIG. 4); (iii) predict stock factor going forward; (iv) predict aging due to expiry and/or seasonality; (v) obtain the current supply forecast (e.g., 406 in FIG. 4); (vi) recommend an inventory balancing plan (e.g., 422 in FIG. 4) comprising, by way of example, material movement between the sites inside (or sometimes outside) a cluster to satisfy demand using the lowest transportation cost; (vii) adjust (revise) the supply forecast (e.g., 424 in FIG. 4) to one or more suppliers for fresh item delivery; (viii) send the revised supply forecast to the one or more suppliers; and (ix) send the balancing recommendations (inventory balancing plan) to individual sites (site owners).

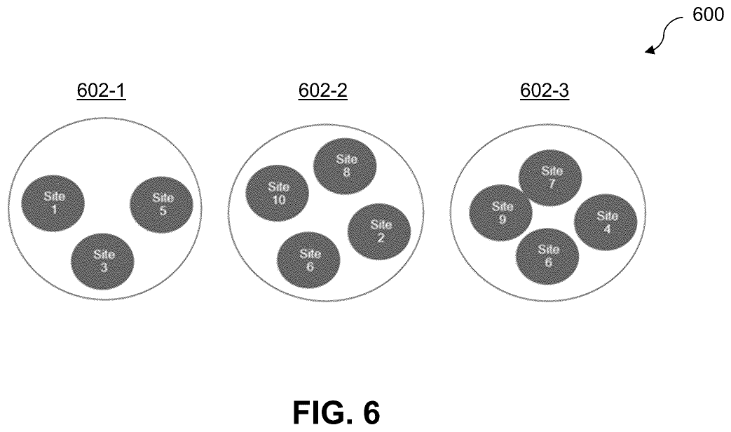

FIG. 6 illustrates a site clustering arrangement 600 for the above-described use case according to one illustrative embodiment. As shown, a first site cluster 602-1 comprises sites S1, S3, and S5, a second site cluster 602-2 comprises sites S2, S6, S8, and S10, and a third site cluster 602-3 comprises S4, S6, S7, and S9. Note that S6 is in two clusters based on its location with respect to the other sites. In some embodiments, a clustering algorithm can be employed to designate clusters and assign sites to given clusters. Alternatively, site-site transportation cost metrics, such as those conceptually represented by table 500 of FIG. 5, can be used to assign sites to a cluster based on the transaction cost between the sites. It is realized that improved (e.g., optimal) transportation costs will occur inside a cluster, while going outside a cluster increases transportation costs as distances between clusters increases. So, if the distance between sites is more than the distance encompassed by a given cluster, the OEM may decide not to go forward with such a material movement as the inter-site transportation costs will be higher than the supplier transportation plus parts cost (i.e., ordering parts from a supplier to be shipped to the site with the shortage).

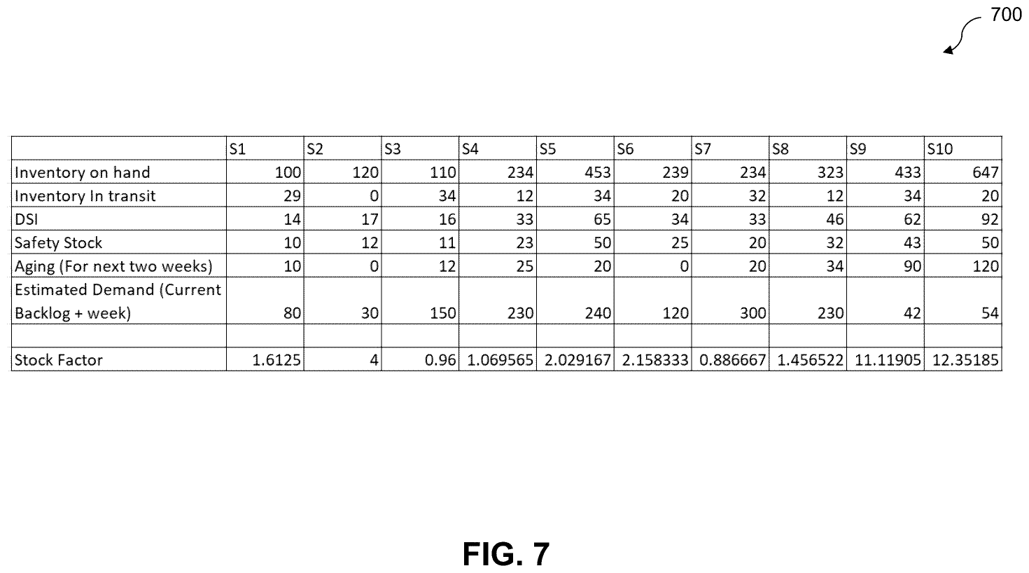

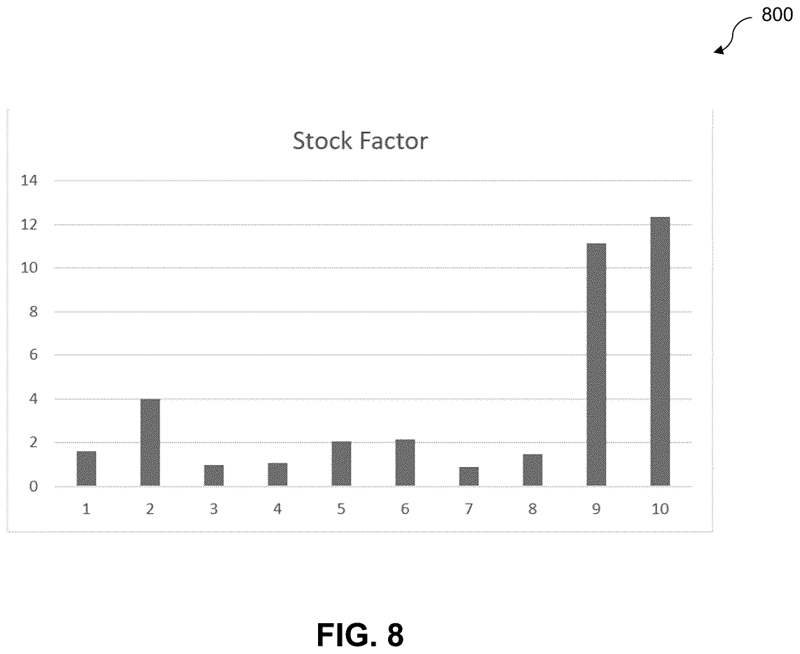

Now consider the previous use case (i.e., FIGS. 2A-2F for sites S1-S10) and, in accordance with illustrative embodiments, stock factor data is obtained such that a stock factor for each site can be determined as shown in table 700 of FIG. 7. In one illustrative embodiment, the stock factor is computed as: (inventory on hand+inventory in transit)/estimated demand. FIG. 8 illustrates a stock factor graphical plot 800 for the stock factor values in table 700 of FIG. 7. From this data, it is evident that sites S9 and S10 have surplus inventory and sites S3, S4, and S7 are tending towards a parts shortage.

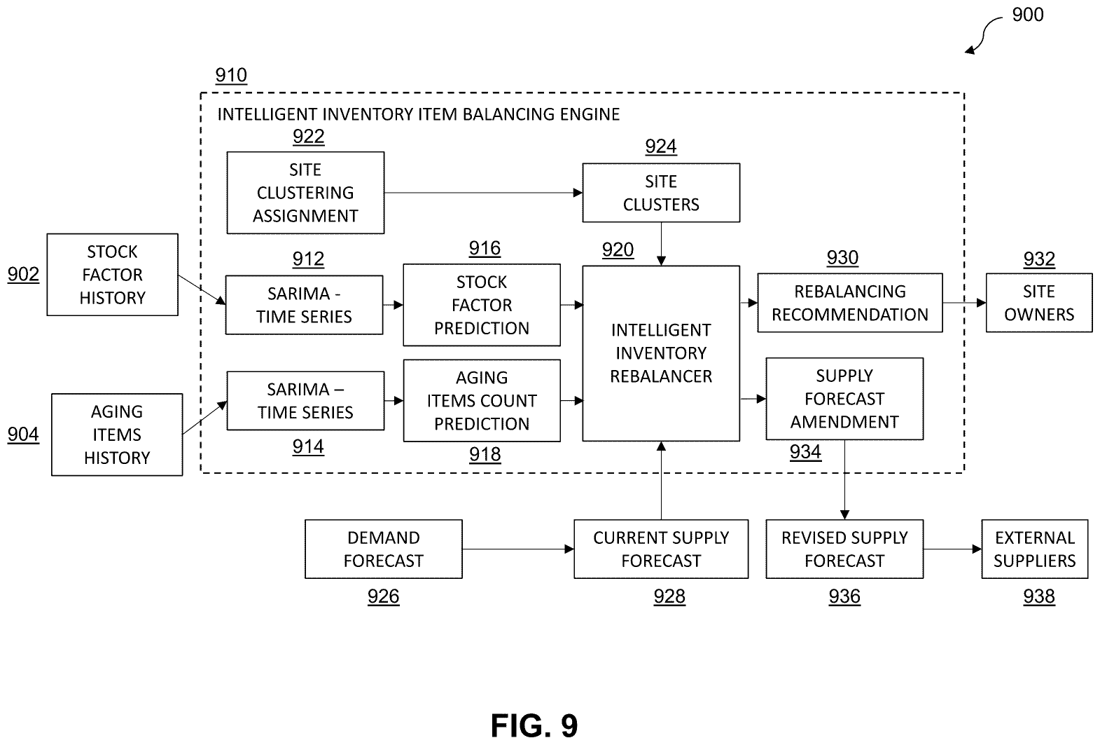

FIG. 9 illustrates an information processing system environment 900 comprising details of an intelligent inventory item balancing engine according to an illustrative embodiment. More particularly, an intelligent inventory item balancing engine 910 is shown in FIG. 9 which can be considered a more detailed diagram of intelligent inventory item balancing engine 410 of FIG. 4. As shown, intelligent inventory item balancing engine 910 inputs stock factor history 902 and aging items history 904. Intelligent inventory item balancing engine 910 comprises a first seasonal autoregressive integrated moving average (SARIMA) time series module 912 that receives stock factor history 902 and a second SARIMA time series module 914 that receives aging items history 904.

It is to be appreciated that intelligent inventory item balancing engine 910 uses stock factor history 902 so that it can predict the stock factor for a next time period (e.g., next weeks, months, etc.) for each site based on stock factor history 902. SARIMA time series is used as the data model in this illustrative embodiment, as there is a linearity in the data set and seasonality changes. Such stock factor prediction is performed by stock factor prediction module 916 based on the output of SARIMA time series module 912. One or more machine learning algorithms can be used to perform the stock factor prediction.

Similarly, intelligent inventory item balancing engine 910 uses aging items history 904 so that it can predict the aging items count for a next time period (e.g., next weeks, months, etc.) for each site based on aging items history 904. Such aging items count prediction is performed by aging items count prediction module 918 based on the output of SARIMA time series module 914. One or more machine learning algorithms can be used to perform the aging items count prediction.

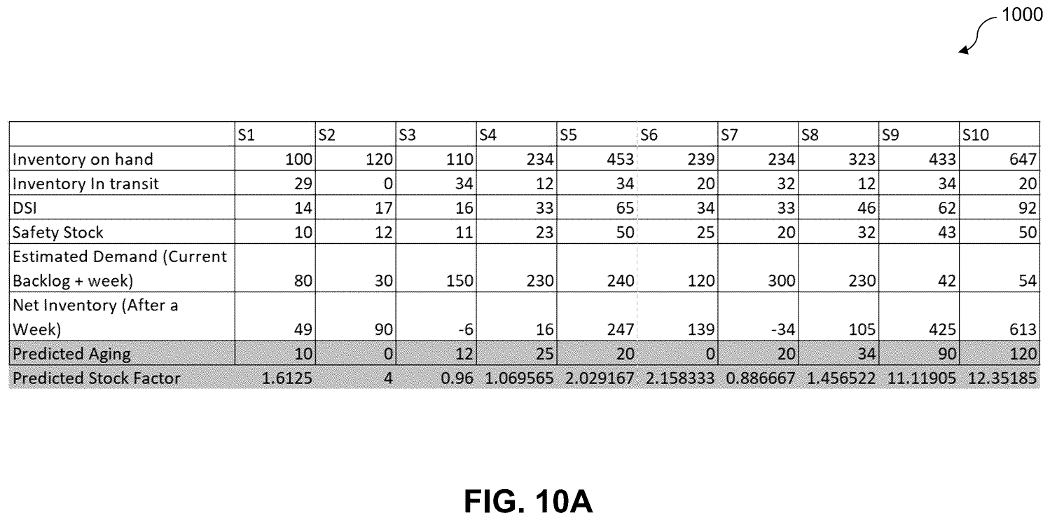

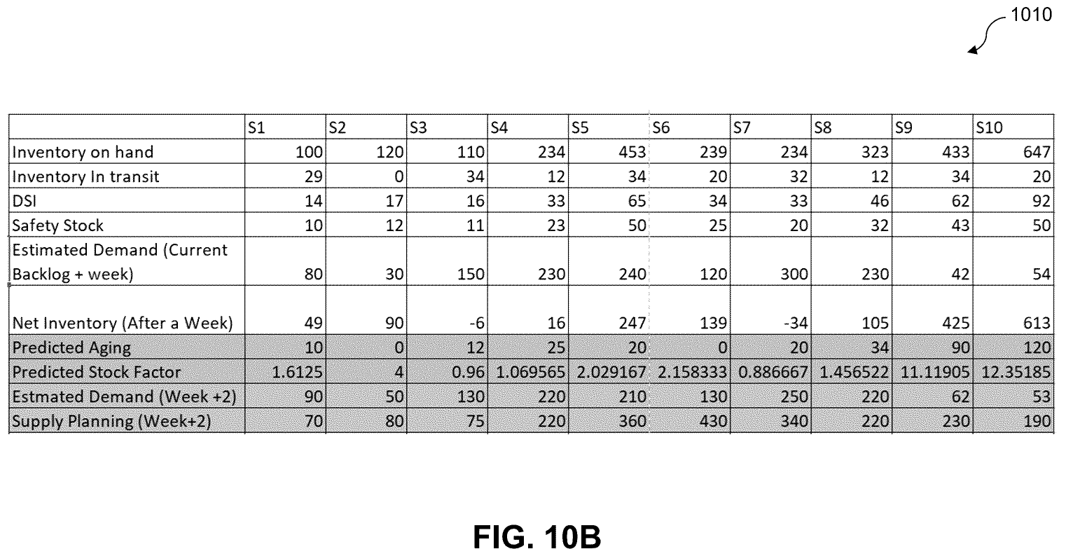

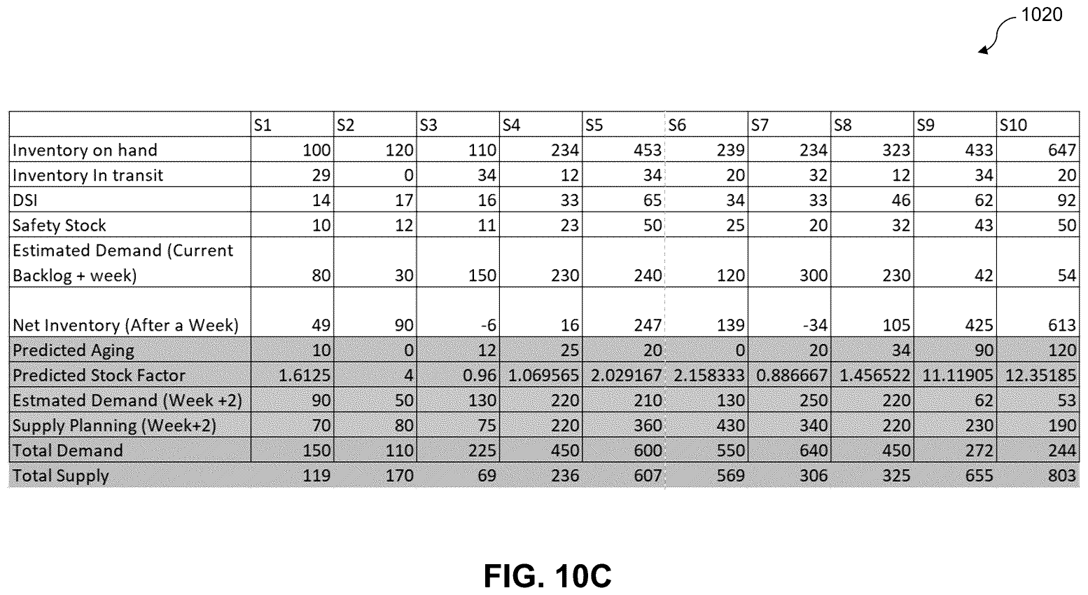

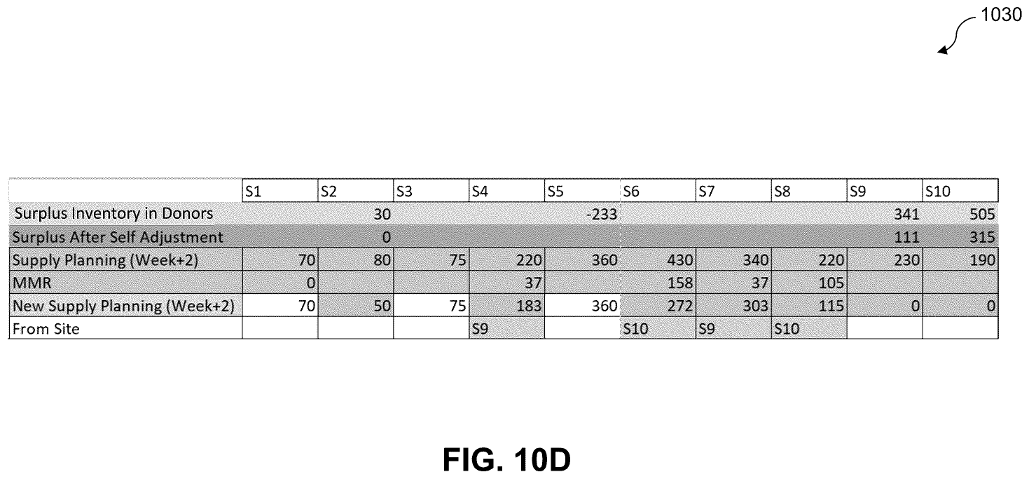

Table 1000 of FIG. 10A shows predicted aging items count and predicted stock factor results (for Week+2) respectively generated by stock factor prediction module 916 and aging items count prediction module 918.

It is realized herein that each OEM may prefer to use a different stock factor. Assume here the stock factor preferred by a given OEM is 2. So, it is evident that S3, S9, S10 would be operating on a surplus and S5 is tending toward a surplus. Table 1010 of FIG. 10B then shows the demand planning and supply planning for Week+2 which is obtained using standard supply planning of the given OEM (e.g., FIG. 3).

Returning to FIG. 9, predicted stock factors from stock factor prediction module 916, predicted aging items count from aging items count prediction module 918, and a designation of site clusters 924 are input to an intelligent inventory rebalancer 920 in intelligent inventory item balancing engine 910. One or more machine learning algorithms can be used by intelligent inventory rebalancer 920. Note that intelligent inventory item balancing engine 910 also comprises a site clustering assignment module 922 that assigns sites to one of multiple site clusters, e.g., as explained above in the context of FIG. 6, to generate designation of site clusters 924. In addition, a demand forecast 926 is used to generate a current supply forecast 928, which is also input to intelligent inventory rebalancer 920 as further shown in FIG. 9.

Based on these inputs, intelligent inventory rebalancer 920 calculates a total demand (e.g., Current Demand+Current Backlogs+Week plus 2 Estimated Demand) and total supply (e.g., Last Net Inventory+Supply Planning Week+2) for each of sites S1-S10. Table 1020 in FIG. 10C illustrates the total demand and total supply computation results.

From the stock factor forecast, intelligent inventory rebalancer 920 determines potential donors. For example, with a stock factor or SF of 2, intelligent inventory rebalancer 920 determines which sites can give parts with an SF>2. In this use case, potential donors can be S2 (aging 0), S5 (aging 20), S6 (aging 0), S9 (aging 90), and S10 (aging 120). Intelligent inventory rebalancer 920 then sorts the potential donors by descending aging to generate a list as (S10, S9, S5, S6, S3). Intelligent inventory rebalancer 920 then calculates the surplus in each of these potential donor sites to bring its SF=2.

As depicted in table 1030 of FIG. 10D, S5 is determined to be tending toward a negative (-233), and so is discarded as a potential donor. Thus, remaining donors in ascending order are:

(i) S10 which can move 505 surplus items; (ii) S9 which can move 341 surplus items; and (iii) S2 which can move 30 surplus items. Now assuming that designation of site clusters 924 is what is reflected in FIG. 6, intelligent inventory rebalancer 920 can generate a rebalancing recommendation 930 (inventory balancing plan 422 in FIG. 4) wherein:
S10 can move material to S6 and S8 in site cluster 602-2.
S9 can move material to S4 and S7 in site cluster 602-3.

Since S1, S3, and S5 in site cluster 602-1 do not have a donor in their cluster, intelligent inventory rebalancer 920 finds the nearest cluster (site cluster 602-2) and finds S2 as a donor.

S10 attempts to self-compensate the existing demand and supply first and then moves materials to S6 and S8 (505/2 each or according to the original supply planning).

S9 attempts to self-compensate the existing demand and supply first and then moves materials to S4, S6, and S7 (341/3 each or according to the original supply planning).

S2 attempts to self-compensate the existing demand and supply first and then moves material to a closest site in cluster 602-1 as the cost will be more for an inter-cluster transfer (e.g., move 30 items from S2 to S1).

Thus, rebalancing recommendation 930 is sent to site owners 932 as follows:
S9 to S4-183;
S9 to S7-303;
S10 to S6-272; and
S10 to S8 — 115.

Assuming the site owners agree, intelligent inventory rebalancer 920 recalculates current supply forecast 928, generates a supply forecast amendment 934 therefrom that accounts for the rebalancing recommendation 930, and applies supply forecast amendment 934 to generate a revised supply forecast 936. Revised supply forecast 936 is provided to external suppliers 938.

Advantageously, in accordance with intelligent inventory item balancing engine 910, for this particular use case, the following occurs:
Total supply planning to external suppliers before rebalancing=2215;
New supply planning to external suppliers after rebalancing=1428;
Total expected aging after rebalancing and next supply plan=approx. 0; and
Stock factor converges to 2 (initially defined).

The same cycle continues in the next supply planning operation.

Also, there is no restriction that intelligent inventory item balancing engine 910 can only run in the supply planning cycle, rather it can run in any manner to rebalance inventory as needed or desired. More particularly, intelligent inventory item balancing engine 910 advantageously predicts the stock factor and aging parts per site using a SARIMA time series data model, uses the predictions along with the current supply planning to compute an improved (e.g., optimal) material movement plan by clustering sites based on transportation cost, and improves the current supply planning. Advantageously, intelligent inventory item balancing engine 910 provides an intelligent way to consume aging parts using improved (e.g., optimal) material movement within sites, as well as an intelligent way to bring the stock factor under control using improved (e.g., optimal) material balancing.

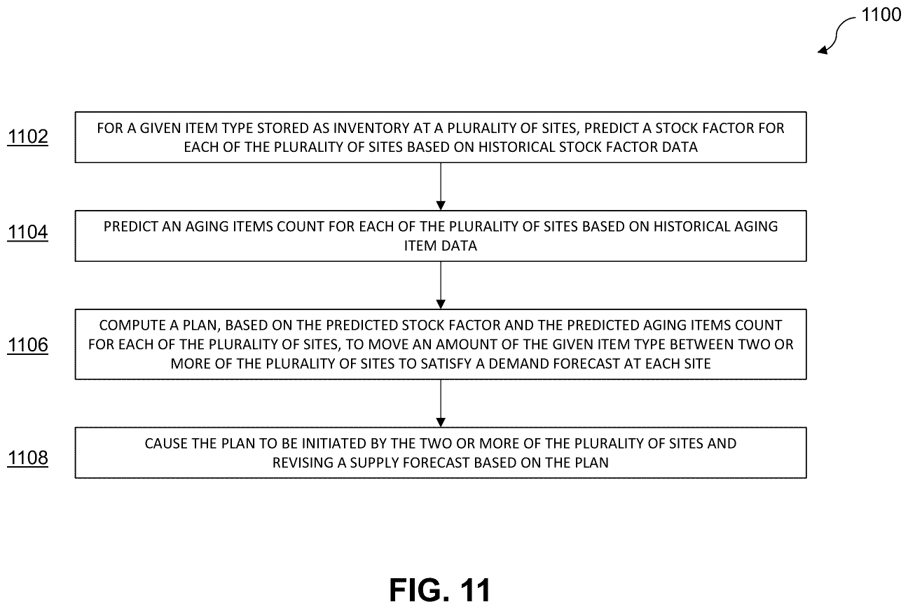

FIG. 11 summarizes an intelligent inventory item balancing methodology 1100, according to an illustrative embodiment, for a given item type stored as inventory at a plurality of sites.

Step 1102 predicts a stock factor for each of the plurality of sites based on historical stock factor data.

Step 1104 predicts an aging items count for each of the plurality of sites based on historical aging item data.

Step 1106 computes a plan, based on the predicted stock factor and the predicted aging items count for each of the plurality of sites, to move an amount of the given item type between two or more of the plurality of sites to satisfy a demand forecast at each site.

Step 1108 causes the plan to be initiated by the two or more of the plurality of sites and revises a supply forecast based on the plan.

Illustrative embodiments are described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Cloud infrastructure can include private clouds, public clouds, and/or combinations of private/public clouds (hybrid clouds).

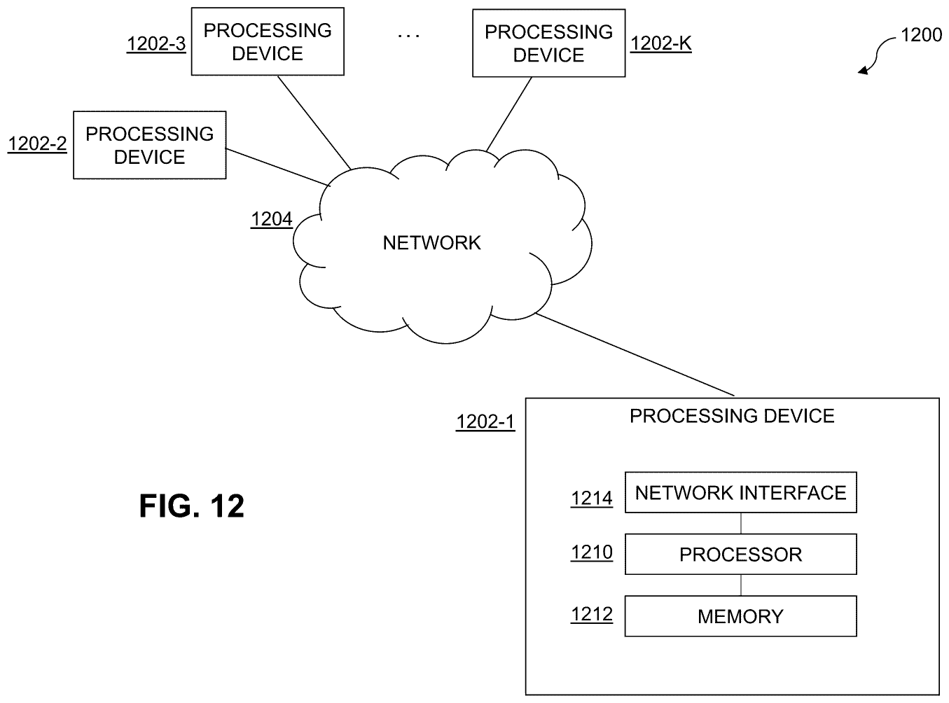

FIG. 12 depicts a processing platform 1200 used to implement systems/processes/data depicted in FIGS. 1 through 10D, respectively, according to an illustrative embodiment. More particularly, processing platform 1200 is a processing platform on which a computing environment with functionalities described herein can be implemented.

The processing platform 1200 in this embodiment comprises a plurality of processing devices, denoted 1202-1, 1202-2, 1202-3, . . . 1202-K, which communicate with one another over network(s) 1204. It is to be appreciated that the methodologies described herein may be executed in one such processing device 1202, or executed in a distributed manner across two or more such processing devices 1202. It is to be further appreciated that a server, a client device, a computing device or any other processing platform element may be viewed as an example of what is more generally referred to herein as a “processing device.” As illustrated in FIG. 12, such a device generally comprises at least one processor and an associated memory, and implements one or more functional modules for instantiating and/or controlling features of systems and methodologies described herein. Multiple elements or modules may be implemented by a single processing device in a given embodiment. Note that components described in the architectures depicted in the figures can comprise one or more of such processing devices 1202 shown in FIG. 12. The network(s) 1204 represent one or more communications networks that enable components to communicate and to transfer data therebetween, as well as to perform other functionalities described herein.

The processing device 1202-1 in the processing platform 1200 comprises a processor 1210 coupled to a memory 1212. The processor 1210 may comprise a microprocessor, a microcontroller, an application-specific integrated circuit (ASIC), a field programmable gate array (FPGA) or other type of processing circuitry, as well as portions or combinations of such circuitry elements. Components of systems as disclosed herein can be implemented at least in part in the form of one or more software programs stored in memory and executed by a processor of a processing device such as processor 1210. Memory 1212 (or other storage device) having such program code embodied therein is an example of what is more generally referred to herein as a processor-readable storage medium. Articles of manufacture comprising such computer-readable or processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 1212 may comprise electronic memory such as random-access memory (RAM), read-only memory (ROM) or other types of memory, in any combination. The one or more software programs when executed by a processing device such as the processing device 1202-1 causes the device to perform functions associated with one or more of the components/steps of system/methodologies in FIGS. 1 through 10D. One skilled in the art would be readily able to implement such software given the teachings provided herein. Other examples of processor-readable storage media embodying embodiments of the invention may include, for example, optical or magnetic disks.

Processing device 1202-1 also includes network interface circuitry 1214, which is used to interface the device with the networks 1204 and other system components. Such circuitry may comprise conventional transceivers of a type well known in the art.

The other processing devices 1202 (1202-2, 1202-3, . . . 1202-K) of the processing platform 1200 are assumed to be configured in a manner similar to that shown for computing device 1202-1 in the figure.

The processing platform 1200 shown in FIG. 12 may comprise additional known components such as batch processing systems, parallel processing systems, physical machines, virtual machines, virtual switches, storage volumes, etc. Again, the particular processing platform shown in this figure is presented by way of example only, and the system shown as 1200 in FIG. 12 may include additional or alternative processing platforms, as well as numerous distinct processing platforms in any combination.

Also, numerous other arrangements of servers, clients, computers, storage devices or other components are possible in processing platform 1200. Such components can communicate with other elements of the processing platform 1200 over any type of network, such as a wide area network (WAN), a local area network (LAN), a satellite network, a telephone or cable network, or various portions or combinations of these and other types of networks.

Furthermore, it is to be appreciated that the processing platform 1200 of FIG. 12 can comprise virtual (logical) processing elements implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 1200 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other.

It was noted above that portions of the computing environment may be implemented using one or more processing platforms. A given such processing platform comprises at least one processing device comprising a processor coupled to a memory, and the processing device may be implemented at least in part utilizing one or more virtual machines, containers or other virtualization infrastructure. By way of example, such containers may be Docker containers or other types of containers.

The particular processing operations and other system functionality described in conjunction with FIGS. 1-12 are presented by way of illustrative example only, and should not be construed as limiting the scope of the disclosure in any way. Alternative embodiments can use other types of operations and protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the above-described embodiments of the invention are presented for purposes of illustration only. Many variations may be made in the particular arrangements shown. For example, although described in the context of particular system and device configurations, the techniques are applicable to a wide variety of other types of data processing systems, processing devices and distributed virtual infrastructure arrangements. In addition, any simplifying assumptions made above in the course of describing the illustrative embodiments should also be viewed as exemplary rather than as requirements or limitations of the invention.

What is claimed is:

1. An apparatus comprising:
at least one processing device comprising a processor coupled to a memory, the at least one processing device, when executing program code, is configured to:
for a given item type stored as inventory at a plurality of sites;
predict a stock factor for each of the plurality of sites based on historical stock factor data;
predict an aging items count for each of the plurality of sites based on historical aging item data; and
compute a plan, based on the predicted stock factor and the predicted aging items count for each of the plurality of sites, to move an amount of the given item type between two or more of the plurality of sites to satisfy a demand forecast at each site.

2. The apparatus of claim 1, wherein the at least one processing device, when executing program code, is further configured to cause the plan to be initiated by the two or more of the plurality of sites.

3. The apparatus of claim 1, wherein the at least one processing device, when executing program code, is further configured to revise a supply forecast based on the plan.

4. The apparatus of claim 3, wherein the at least one processing device, when executing program code, is further configured to cause the revised supply forecast to be implemented with respect to one or more suppliers of the given item type.

5. The apparatus of claim 1, wherein the stock factor at each of the plurality of sites is computed as an items count in inventory divided by an estimated demand.

6. The apparatus of claim 5, wherein the items count in inventory comprises on hand items and in transit items.

7. The apparatus of claim 1, wherein the aging items count at each of the plurality of sites is computed as the number of items expiring within a given time period.

8. The apparatus of claim 1, wherein the at least one processing device, when executing program code, is further configured to assign each of the plurality of sites to two or more site clusters.

9. The apparatus of claim 8, wherein the at least one processing device, when executing program code, is further configured to compute the plan based on which of the plurality of sites are assigned to which of the two or more site clusters.

10. The apparatus of claim 1, wherein the at least one processing device, when executing program code, is further configured to compute the plan based on one or more transportation factors associated with moving an amount of the given item type between two or more of the plurality of sites.

11. A method comprising:
for a given item type stored as inventory at a plurality of sites;
predict a stock factor for each of the plurality of sites based on historical stock factor data;
predict an aging items count for each of the plurality of sites based on historical aging item data; and
compute a plan, based on the predicted stock factor and the predicted aging items count for each of the plurality of sites, to move an amount of the given item type between two or more of the plurality of sites to satisfy a demand forecast at each site;
wherein the predicting and computing steps are performed by at least one processing device comprising a processor coupled to a memory when executing program code.

12. The method of claim 11, further comprising causing the plan to be initiated by the two or more of the plurality of sites.

13. The method of claim 11, further comprising revising a supply forecast based on the plan.

14. The method of claim 11, wherein the stock factor at each of the plurality of sites is computed as an items count in inventory divided by an estimated demand.

15. The method of claim 11, wherein the aging items count at each of the plurality of sites is computed as the number of items expiring within a given time period.

16. The method of claim 11, further comprising assigning each of the plurality of sites to two or more site clusters.

17. The method of claim 16, wherein computing the plan is based on which of the plurality of sites are assigned to which of the two or more site clusters.

18. The method of claim 11, wherein computing the plan is based on one or more transportation factors associated with moving an amount of the given item type between two or more of the plurality of sites.

19. A computer program product comprising a non-transitory processor-readable storage medium having stored therein program code of one or more software programs, wherein the program code when executed by at least one processing device cause the at least one processing device to:
for a given item type stored as inventory at a plurality of sites;
predict a stock factor for each of the plurality of sites based on historical stock factor data;
predict an aging items count for each of the plurality of sites based on historical aging item data; and
compute a plan, based on the predicted stock factor and the predicted aging items count for each of the plurality of sites, to move an amount of the given item type between two or more of the plurality of sites to satisfy a demand forecast at each site.

20. The computer program product of claim 19, further comprising one or more of:
causing the plan to be initiated by the two or more of the plurality of sites; and
revising a supply forecast based on the plan.
